(19) United States
(12) Patent Application Publication
(10) Pub. No.: US 2009/0162584 A1
(43) Pub. Date: Jun. 25, 2009

(54) RE-WORKABLE PRESSURE VESSELS FOR SUPERCONDUCTING MAGNET ARRANGEMENTS

(75) Inventors: Matthew Hobbs, Oxford (GB); Mark James LeFeuvre, Littlemore (GB); Edgar Charles Malcolm Rayner, North Moreton (GB)

Correspondence Address: CROWELL & MORING LLP;INTELLECTUAL PROPERTY GROUP, P.O. BOX 14300, WASHINGTON, DC, 20044-4300, US

(73) Assignee: Siemens Magnet Technology Ltd., Witney (GB)

(21) Appl. No.: 12/337,308

(22) Filed: Dec. 17, 2008

(30) Foreign Application Priority Data
Dec. 18, 2007 (GB) 0724573.1

(51) Int. Cl. B32B 1/02; B32B 38/10; B02C 23/00

(52) U.S. Cl. 428/34.1; 156/247; 241/24.28

(57) ABSTRACT

A reworkable pressure vessel for containing a superconducting magnet arrangement. At least first and second separate parts of the vessel are fabricated from fibre-reinforced thermoplastic material. Said first and second parts comprise facing end surfaces adapted for fusion bonding together to form a union closing said vessel such that said vessel can be opened by application of heat and a cutting tool, and re-closed by re-application of fusion bonding to said union.

This invention relates to re-workable pressure vessels for superconducting magnet arrangements, and to methods of making such vessels. It relates especially, though not exclusively, to pressure vessels utilised in magnetic resonance imaging (MRI) systems.

It is well known that, in order to fully test the superconducting magnets which are used in MRI systems, they need to be sealed, as for operation, in a cryostat, including a vacuum pressure vessel usually referred to as an outer vacuum chamber (OVC), which provides thermal isolation from room temperature.

Ideally, if the test is successful, the OVC and the cryogenically cooled superconducting magnet assembly which it contains can be fitted into the MRI system for which it is intended. If, however, the test is unsuccessful, the chamber has to be opened in order to provide access to facilitate the repair or re-working of the magnet assembly.

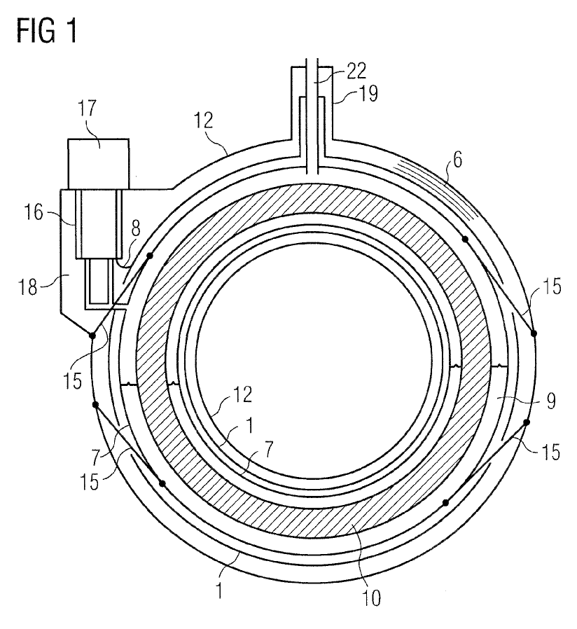

FIG. 1 shows a cross-section through a conventional cryostat housing a superconducting magnet and including an OVC 12. A cooled superconducting magnet 10 is provided within cryogen vessel 7, partially immersed within a liquid cryogen 9. The magnet is held in position relative to the cryogen vessel by suspension means (not shown). The cryogen vessel 7 is itself retained within the outer vacuum chamber (OVC) 12 by suspension means 15 connected between attachment points respectively on the outer surface of the cryogen vessel 7 and the inner surface of the OVC 7. One or more thermal radiation shields 1 are provided in the vacuum space between the cryogen vessel 7 and the outer vacuum chamber 12. The suspension means 15 pass through holes formed for the purpose in the thermal radiation shield(s). The thermal radiation shield(s) 1 are retained in position relative to the cryogen vessel 7 and the OVC 12 by further suspension means (not shown). A number of layers 6 of MYLAR® aluminised polyester film and insulating mesh are typically provided, between the thermal radiation shield 1 and the OVC 12. These layers are only partially shown in FIG. 1, for clarity. The thermal radiation shield 1 and layers 6 minimise heat transfer from the OVC 12 to the cryogen vessel 7 by radiation. The volume between the OVC 12 and the cryogen vessel 7 is evacuated to minimise heat transfer from the OVC to the cryogen vessel by convection.

In some known arrangements, a refrigerator 17 is mounted in a refrigerator sock 16 located in a turret 18 provided for the purpose, towards the side of the cryostat. Alternatively, a refrigerator may be located within access turret 19, which retains access neck (vent tube) 22 mounted at the top of the cryostat. The refrigerator provides active refrigeration to cool cryogen gas within the cryogen vessel 7, in some arrangements by recondensing it into a liquid. The refrigerator 17 may also serve to cool the radiation shield 1 through thermal link 8.

Other components, such as electrical connections to the magnet are provided, but are not illustrated for clarity, and as they play no part in the present invention.

In alternative arrangements, large volumes of liquid cryogen are not used, and no cryogen vessel 7 need be present. However, the OVC 12 is still provided, and the present invention may be applied to such arrangements.

Within the present description, the term “magnet arrangement” may be taken to include at least the magnet 10, the thermal radiation shield 1, any cryogen vessel 7 and liquid cryogen 9, and any solid insulation 6, as well as components not illustrated but accommodated within the OVC 12.

Where, conventionally, the OVC 12 is made of metallic material, it is usual for the magnet arrangement to be sealed into the OVC by welding. Opening such an OVC requires the welds, or another part of the OVC body, to be cut. Since this removes material from the OVC body, the original OVC cannot generally be re-used and, whilst some at least of the metallic material can be recycled, and does not therefore pose a significant disposal problem, as regards landfill for example, the operation as a whole is wasteful of material and rather costly. In this latter respect, it will be appreciated that the time and cost involved in the assembly of a metallic OVC is considerable, requiring several hours of skilled and qualified labour.

It has thus been proposed to fabricate OVC enclosures from fibre-reinforced composite thermosetting plastics materials. Such OVCs do not require welding. However, OVCs so fabricated need, like their metallic counterparts, to be cut open when testing indicates that magnet repairs are called for, and the situation is thus little improved. Furthermore the OVC, having been cut open, cannot be re-used and the scrapped OVC has to be disposed of. Fibre-reinforced thermosetting plastics materials are generally non-recyclable, however, and it is becoming increasingly unacceptable, as well as expensive, to send such materials to landfill sites for disposal.

It will further be appreciated that, whether or not a magnet system contained in an OVC made of thermosetting plastics needs re-working after test, the problem of acceptably disposing of the OVC still arises at the end of the product's working life.

There are thus requirements for improved demountable pressure vessels for superconducting magnet arrangements and for improved methods of manufacturing, opening and re-closing such vessels, and it is an object of the present invention to address these requirements.

According to the invention from one aspect, there is provided a reworkable pressure vessel for containing a superconducting magnet arrangement. At least first and second separate parts of the vessel are fabricated from fibre-reinforced thermoplastic material. Said first and second parts comprise facing end surfaces adapted for fusion bonding together to form a union closing said vessel such that said vessel can be opened by application of heat and a cutting tool, and re-closed by re-application of fusion bonding. Parts of such pressure vessels are thus readily secured together by means of fusion bonding, which is a reversible process, thereby permitting the vessel to be opened so as to provide access to superconducting magnet components enclosed therein, and its subsequent re-closure.

The opening of the vessel is preferably performed without loss of material. For example, a heated cutting tool, such as a wire or a blade, may be applied to cut open the vessel by displacing softened fibre-reinforced thermoplastic material away from the cutting path. The heat and the tool may be applied separately, in quick succession.

In some preferred embodiments, the fusion bonding processes used to re-close the vessel comprises a re-application of the same process used to effect the original bond. In other embodiments, different fusion bonding processes from that used for the original bond may be used for re-closure.

It is preferred that the fusion bonding process used is chosen from a group of processes comprising: hot tool welding; infra-red welding; laser welding; spin welding; ultrasonic welding; vibration welding; and resistance welding.

It is preferred that the thermoplastics material comprises polypropylene or polyethylene.

In some preferred embodiments, at least an outer shell of the pressure vessel is formed entirely of said reinforced thermoplastics material.

The invention thus provides that pressure vessels opened to permit the repair of magnets that fail during testing can be re-sealed. Moreover, pressure vessels constructed of fibre reinforced thermoplastics materials can be recycled at the end of the product life using standard plastic recycling methods. One example of such a method comprises the removal of any metallic inserts followed by grinding of the remaining fibres and plastics material which is then shredded into small pieces and fed into a granulator, ultimately producing small pellets that can be used as raw material in a standard extrusion/compression moulding apparatus.

According to the invention from another aspect, there is provided a method of manufacturing a pressure vessel for containing a superconducting magnet arrangement, which pressure vessel can subsequently be opened and re-closed, the method comprising the steps of:

fabricating first and second separate parts of the vessel from fibre-reinforced thermoplastics material; said first and second parts comprising facing end surfaces adapted to abut in fitting relationship;
fusion bonding said abutting end surfaces together to form a union closing said vessel; opening the vessel by application of heat and a cutting tool; and re-applying thermal bonding to re-close said vessel.

In order that the present invention may be clearly understood and readily carried into effect, one embodiment thereof will now be described, by way of non-limiting example only, with reference to the accompanying drawings, wherein:

FIG. 1 illustrates a cross-section of a conventional cryostat containing a cryogenically cooled magnet;

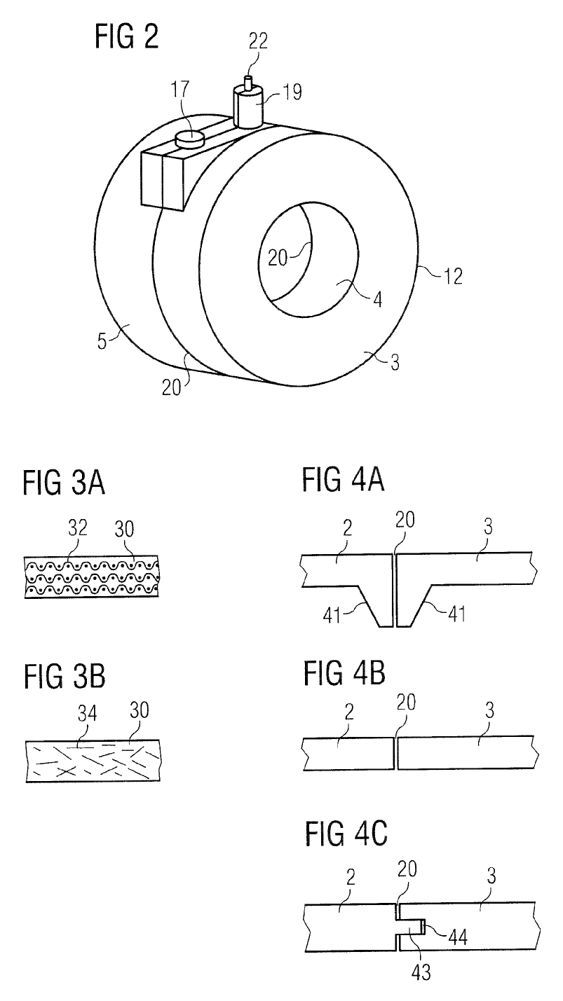

FIG. 2 shows a perspective view of a cryostat according to an embodiment of the present invention;

FIGS. 3A and 3B show schematic cross sections of materials used to form the OVC of a cryostat such as shown in FIG. 2, according to embodiments of the present invention; and

FIGS. 4A-4C show schematic cross-sections of first and second parts of an OVC of the present invention, having facing end surfaces adapted for fusion bonding together, according to embodiments of the present invention.

In accordance with one example of the invention from one aspect, a reworkable pressure vessel constituting an OVC comprises two substantially symmetrical housing parts, both made essentially of fibre-reinforced thermoplastics material. Essentially, the two parts each form a half of the OVC, and they are formed with identical end surfaces designed to accurately match one another, and to be placed into abutting relationship when the OVC is to be closed.

The OVC is typically formed with, or contains, internal fitments associated with the retention and operation of a superconducting magnet arrangement.

Upon closure, these end surfaces are fusion bonded together to form a union closing the OVC, which can then be submitted to tests in the usual way to determine, inter alia, the functional and operational status of the magnet assembly housed therein.

FIG. 2 shows a schematic perspective view of such an embodiment of the invention. As is shown in FIG. 2, the OVC 12 is typically a generally cylindrical annular structure with two annular end faces 3, only one of which is visible, an inner cylinder 4 and an outer cylinder 5. The OVC is formed of two substantially identical parts, which in this example each comprise an end face 3, and a half of the inner cylinder 4 and a half of the outer cylinder 5. The halves join at a seam 20 which extends around both inner 4 and outer 5 cylinders. Features are provided to house non-cylindrical features such as refrigerator 17 and vent tube 22. Features will be provided to ensure that the OVC may be stably positioned on a supporting surface. These features may be feet formed as part of the OVC halves, or may be separate parts.

The seam 20 is where facing end surfaces of the two halves meet. At the seam, a thermal fusion bonding process is applied to fuse the facing end surfaces together into a union and complete the OVC.

The thermal bonding process used to form the union is reversible and repeatable. Thus, in accordance with a principal feature of the invention, the OVC can be opened and re-closed. For example, the vessel may be opened by applying heat and a cutting tool, for example a heated blade or a heated cutting wire, to the vessel. Alternatively, heat may be applied separately, immediately before the cutting tool is applied. The vessel may then be re-closed by reapplication of fusion bonding. Such pressure vessels are thus readily opened, without loss of material so as to provide access to the superconducting magnet components enclosed therein for repair or reconfiguration, and subsequently re-closed by the re-application of fusion bonding without loss of material or damage to the existing vessel components.

The fusion bonding process comprises an application of heat to the two abutting surfaces to be united, and a suitably timed application of pressure by means of opposing forces. These operations are well known to those skilled in the art, and are readily applied to the present context.

Typical fusion bonding processes usable in embodiments of the invention include: hot tool welding; infra-red welding; laser welding; spin welding; ultrasonic welding; vibration welding; and resistance welding. In this connection, it will be appreciated that the process used at any stage, and in any given embodiment of the invention, may be dictated by factors such as the dimensions of the OVC, by operational requirements or simply by process availability and/or by the degree of familiarity of available personnel with certain processes.

Indeed, in some embodiments, the fusion bonding process used to re-close the vessel may comprise a re-application of the same process used to effect the original bond. In other embodiments, however, different fusion bonding processes from that used for the original bond may be used for re-closure.

It is preferred that the thermoplastics material comprises polypropylene or polyethylene. The fibre reinforcement preferably comprises multidirectional fibre matting in order to cope with the forces which a pressure vessel adapted to contain a superconducting magnet is subjected to.

FIGS. 3A and 3B show schematic cross sections of materials used to form the OVC of a cryostat such as shown in FIG. 2, according to embodiments of the present invention. In each case, a thermoplastic material 30 is reinforced with a fibrous material. In the embodiment of FIG. 3A, multiple layers of fibre matting 32 are provided. The matting may be woven, as illustrated, or non-woven. In the embodiment shown in FIG. 3B, strands of fibrous material are mingled into the thermoplastic material 30. Further arrangements will be apparent to those skilled in the art.

The two halves of the OVC described above are preferably formed entirely of the reinforced thermoplastics material. If operational or other requirements so dictate, however, the OVC may contain, or be partially formed of, metallic or other materials. For example, metallic fittings may be provided within the OVC at attachment points for mounting suspension elements such as shown at 15 in FIG. 1.

As previously mentioned, pressure vessels constructed of fibre reinforced thermoplastics materials can be recycled at the end of the product life using standard plastic recycling methods.

The invention further provides a method of manufacturing a pressure vessel that can subsequently be opened and re-closed, and which is adapted to contain superconducting magnet arrangements. In one embodiment, the method requires: fabricating, from fibre-reinforced thermoplastics material, first and second separate parts of the vessel, the parts having respective facing end surfaces; bringing the end surfaces into abutting relationship; fusion bonding the abutting end surfaces together to form a union closing the vessel; opening the vessel, preferably without loss of material, by applying heat and a cutting tool, then re-closing the vessel by repeated application of fusion bonding.

The step of fabricating first and second parts of the fibre-reinforced thermoplastics vessel may be achieved by using a sheet of fibrous material, such as glass-fibre matting, or felt, pre-impregnated with a thermoplastic. Such sheet material may be formed into desired shapes by heating and forming in a press, similar to a metal pressing operation. The thermoplastic vessel may be constructed by pressing end faces 3, forming inner and outer cylinders 4, 5 by rolling and fusion bonding a sheet of fibre-reinforced thermoplastic, then fusion bonding the cylinders and the end faces together. The thermoplastic material forms reworkable joints and is simpler to join as apposed to the conventional metal welding methods.

FIGS. 4A-4C show schematic cross-sections of edge parts of first and second parts of an OVC of the present invention, having facing end surfaces adapted for fusion bonding together at seam 20, according to embodiments of the present invention. In each case, the OVC halves are shown slightly separated, for the purposes of illustration. When thermal fusion bonding is to take place, the OVC halves will be pushed firmly together. In the embodiment of FIG. 4A, each end face is formed on a raised flange 41 provided on each OVC half, the length of the seam 20. During thermal fusion bonding, at least a part of each flange is melted, and the flanges are pressed together to form a union. In the embodiment of FIG. 4B, each end face is formed perpendicular to inner and outer surfaces of the OVC. During thermal fusion bonding, at least a part of each end face is melted, and the OVC halves are pressed together to form a union. In the embodiment of FIG. 4C, one facing end surface is formed with a protruding tongue 43, while the other facing end surface is formed with a complementary groove channel 44. Such arrangement may assist in locating the two OVC halves together before thermal fusion bonding. During thermal fusion bonding, at least a part of each facing end surface is melted, and the OVC halves are pressed together to form a union.

While polypropylene and polyethylene have been suggested as suitable thermoplastic materials, other thermoplastic materials may be employed, according to the required mechanical strength and thermal properties of the vessel. Similarly, the fibre reinforcement will typically comprise glass fibres, but may alternatively or in addition comprise carbon fibres, aramid fibres or any other fibrous material considered to have suitable thermal and mechanical properties.

1. A reworkable pressure vessel for containing a superconducting magnet arrangement; at least first and second separate parts of the vessel being fabricated from fibre-reinforced thermoplastics material; wherein said first and second parts comprise facing end surfaces adapted for fusion bonding together to form a union closing said vessel such that said vessel can be opened by application of heat and a cutting tool, and re-closed by re-application of fusion bonding to said union.

2. A vessel according to claim 1, wherein the thermoplastics material comprises polypropylene or polyethylene.

3. A vessel according to claim 1, wherein the fusion bonding process used to form said union is chosen from the group comprising: hot tool welding; infra-red welding; laser welding; spin welding; ultrasonic welding; vibration welding; and resistance welding.

4. A vessel according to claim 3, wherein the same fusion bonding process used to form said union is utilised for said re-application.

5. A vessel according to claim 1, wherein at least an outer shell of the pressure vessel is formed entirely of said reinforced thermoplastics material.

6. A method of manufacturing a pressure vessel for containing a superconducting magnet arrangement, which pressure vessel can subsequently be opened and re-closed, the method comprising the steps of:
fabricating first and second separate parts of the vessel from fibre-reinforced thermoplastics material; said first and second parts comprising facing end surfaces adapted to abut in fitting relationship;
fusion bonding said abutting end surfaces together to form a union closing said vessel;
opening said vessel by application of heat and a cutting tool; and
re-applying thermal bonding to re-close said vessel.

7. A method according to claim 6, wherein the fusion bonding process used to re-close the vessel comprises a re-application of the same process used to effect the original bond.

8. A method according to claim 6, wherein a different fusion bonding process from that used for the original bond is used for re-closure of the vessel.

9. A method according to claim 6, further comprising recycling the material of the vessel to produce pellets that can be used as raw material in a standard extrusion/compression moulding apparatus.

10. A method according to claim 9 wherein the step of recycling comprises the steps of removing any metallic inserts; grinding of the remaining fibres and plastics material, thereby shredding them into small pieces; and feeding said small pieces into a granulator.

11. A vessel according to claim 2, wherein the fusion bonding process used to form said union is chosen from the group comprising: hot tool welding; infra-red welding; laser welding; spin welding; ultrasonic welding; vibration welding; and resistance welding.

12. A vessel according to claim 2, wherein at least an outer shell of the pressure vessel is formed entirely of said reinforced thermoplastics material.

13. A vessel according to claim 3, wherein at least an outer shell of the pressure vessel is formed entirely of said reinforced thermoplastics material.

14. A vessel according to claim 4, wherein at least an outer shell of the pressure vessel is formed entirely of said reinforced thermoplastics material.

15. A method according to claim 7, further comprising recycling the material of the vessel to produce pellets that can be used as raw material in a standard extrusion/compression moulding apparatus.

16. A method according to claim 8, further comprising recycling the material of the vessel to produce pellets that can be used as raw material in a standard extrusion/compression moulding apparatus.
